(19) United States
(12) Patent Application Publication
(10) Pub. No.: US 2010/0067690 A1
(43) Pub. Date: Mar. 18, 2010

(54) SPA-RESISTANT LEFT-TO-RIGHT RECODING AND UNIFIED SCALAR MULTIPLICATION METHODS

(75) Inventors: Dong-Guk Han, Incheon-city (KR); Doo-Ho Choi, Cheonan-city (KR); Ho-Won Kim, Daejeon-city (KR); Kyo-II Chung, Daejeon-city (KR); Sung-Kyoung Kim, Seoul (KR); Jongin Lim, Seoul (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/516,353

(22) PCT Filed: Jun. 22, 2007
(86) PCT No.: PCT/KR07/03037

§ 371 Date: May 27, 2009

(30) Foreign Application Priority Data
Dec. 6, 2006 (KR) 10-2006-0123392

(51) Int. Cl. H04L 9/28; H04L 9/06

(52) U.S. Cl. 380/44; 380/28

(57) ABSTRACT

Provided is a scalar multiplication method unified with a simple power analysis (SPA) resistant left-to-right recording in a crypto system based on an elliptic curve and a pairing. The scalar multiplication method includes: recording an L-digit secret key k′ from a radix-r n-digit secret key k by comparing two successive elements with each other from the most significant digit with duplication allowed in order to generate the L-digit secret key k′; and performing scalar multiplication between the secret key k and a point P on an elliptic curve to output a scalar multiplication value Q=kP using the secret key k′.

### TECHNICAL FIELD

The present invention relates to SPA-resistant left-to-right recording and unified scalar multiplication methods and more particularly, to a method of using a radix-r private key to provide a fixed pattern operation resistant to a side channel attack, and a left-to-right scalar multiplication algorithm for simultaneously performing both of a recording process and a scalar multiplication process using the above method.

### BACKGROUND ART

As cryptosystems have appropriately adapted to an ever-present computing environment requiring a low power consumption and a small number of resources, an elliptic curve cryptosystem (ECC), paring-based cryptosystems such as a tripartite Diffie-Hellmann scheme, an ID-based cryptosystem, and a short digital signature have become well known in the art, since they allow us to achieve a high level of security even using a small key size.

The most important operations of the paring-based cryptosystems are a paring operation, such as a Weil paring and a Tate paring, and an elliptic curve scalar multiplication. Since most of these operations manipulate secret values related with security of the corresponding cryptosystems and require a lot of time, security and efficiency of the paring-based protocols and cryptosystems depend on both the above operations.

Recently, many studies are being made in the art on efficiency of the pairing computation that has not been focused on as much as scalar multiplication. For example, a method of effectively computing a Tate pairing using a hyper-elliptic curve having a characteristic r, which is a smaller prime number, and particularly, an algorithm optimized to a case where the prime number r is set to 3, has been proposed by Duursma and Lee. Recently, an Eta pairing for very effectively computation of a pairing in an elliptic curve and a hyper-elliptic curve over characteristic 2 or 3 has been proposed.

As described above, most of the pairing-based cryptosystems use an elliptic curve having a characteristic number equal to the smaller prime number r due to efficiency of the pairing operation. However, conventional elliptic curve cryptosystems use a non-supersingular elliptic curve having a characteristic number equal to or larger than 2 (e.g., 163 bits) to implement the scalar multiplication. Accordingly, unlike conventional methods, an effective scalar multiplication algorithm that uses a super-singular elliptic curve defined on a finite extension field GF(q) with characteristic r and extension degree m (i.e., q=r^{m}) is required to be developed to implement the elliptic curve scalar multiplication.

For example, in the super-singular elliptic curve defined on a finite field GF(3^{m}), it is more efficient to compute 3P operation that three times additions of P in comparison with 2P operation that two times additions of P. In this case, it would be more effective to use no binary notation but a ternary notation to represent integers in the scalar multiplication. Therefore, it would be more effective to use a radix-r notation (where, r is a characteristic) instead of the binary notation to implement the scalar multiplication in the pairing cryptosystems.

Scalar multiplication between a given private key k and a point P on the elliptic curve is defined as kP, which is equal to k additions of the point P.

$$k \cdot P = {\underbrace{P + P + … P}}_{k times} \qquad [ Formula 1 ]$$

The scalar multiplication for computing the value of kP depends on the representation of the private key k. For example, if the value of k is expressed as a binary notation, a doubling of the point on the elliptic curve is performed for a digit 0, while both of the doubling and the addition are performed for a digit 1. In addition, if the value of k is expressed as a radix-r notation, an r-tuple operation (rP) is performed for a digit 0 and both of the an r-tuple operation (rP) and the addition are performed for digits other than 0.

A side-channel attack is known as a method of attacking cryptosystems by what find outs the secret key using peripheral-information generated when the algorithm is executed by the cryptosystem. For example, in a power analysis, it is possible to find out the secret key by monitoring a change of the power consumption when the cryptosystems perform operations.

The power analysis attack can be classified into a simple power analysis (SPA) attack and a differential power analysis (DPA) attack. In the SPA, the information on the secret value is obtained from a single power consumption amount. The SPA is based on assumption that the power consumption amount differently appears when different computations are performed in the processors, and the attackers have ability to measure the variations of the power consumption amount. By tracing a single sample, it is possible to recognize what kind of operation is performed in any portion. In the SPA, it is possible to recognize the entire or a portion of the information on the secret value by tracing the power consumption amount in a single time.

The DPA is a method of obtaining information on the secret value from several power consumption amounts. Since the relationship between the information on the secret value and the power consumption amount is obtained from several samples, the DPA can be used for attacks on the cryptosystems resistant to the SPA.

Generally, an addition for adding two points on an elliptic curve and a doubling for doubling a single point are computed using different formulas, and the doubling can be implemented faster than the addition. Therefore, the power consumptions are different between the doubling and addition during the computation, and it is possible to trace the key used in the scalar multiplication using such information.

The aforementioned method of computing the scalar multiplication value kP also includes an ‘if’ clause (i.e., bifurcation) for selectively performing the elliptic curve addition depending on each bit or digit of the secret key k. Therefore, the power consumption amount of the scalar multiplication differently appears depending on whether the traced bit is 0 or 1. Accordingly, it is considered that the scalar multiplication is vulnerable to the SPA.

There are some countermeasures against the SPA attacks: insertion of dummy instructions, unified formulas used in the scalar multiplication, fixed pattern operations using recordings regardless of the secret keys, and the like. Out of them, the recording of the secret keys in a fixed pattern is most commonly used from the viewpoint of efficiency and security. In other words, the SPA attacks can be readily defended by converting the secret key integers used in the scalar multiplication into a novel representation.

Recently, Han-Takagi proposed some recording techniques for expanding the secret key k in radix-r notation using a digit set {±1, ±2, . . . , ±(r−1)} as well as using a window version digit set {±1, ±2, . . . , ±(r^{w}−1)}/{±r, ±2r, . . . , ±(r^{w}−r)}. Both techniques are computed from right to left (i.e., from the least significant bit) of the secret key k, and thus, called ‘right-to-left recordings’.

In general performing scalar multiplication is categorized into two main concepts: left-to-right and right-to-left. Thought both methods provide the same efficiency, the left-to-right method is preferable.

If the recording technique proposed by Han-Takagi is combined with the left-to-right scalar multiplication algorithm as an SPA countermeasure, the scalar multiplication algorithm should be performed after the recording procedure. This is because the recording direction is opposite to the scalar multiplication direction. Therefore, in this case, an additional storage, which is large as the size of the secret key k, should be prepared for storing the generated secret key k.

If the recording technique proposed by Han-Takagi can be computed from left to right (i.e., from the most significant bit), it would be possible to unify the recording algorithm and the left-to-right scalar multiplication algorithm without separately storing the recorded results. Then, it would be possible to reduce the memory as much as the secret key size in comparison with the conventional methods.

### DISCLOSURE OF INVENTION

### Technical Problem

The present invention provides an SPA-resistant left-to-right scalar multiplication algorithm by unifying a process of recording a secret key with a process of scalar multiplication without necessity of a process of storing the recording result.

### Technical Solution

According to an aspect of the present invention, there is provided a scalar multiplication method unified with a simple power analysis (SPA) resistant left-to-right recording in a cryptosystem using an elliptic curve and a pairing, the method comprising: recording an L-digit secret key k′ from a radix-r n-digit secret key k by comparing two successive elements with each other from the most significant digit with duplication allowed in order to generate the L-digit secret key k′; and performing scalar multiplication between the secret key k and a point P on an elliptic curve to output a scalar multiplication value Q=kP using the recorded secret key k′.

### ADVANTAGEOUS EFFECTS

The present invention provides an SPA-resistant left-to-right scalar multiplication algorithm by unifying a process of recording a secret key with a process of scalar multiplication without necessity of a process of storing the recording result.

### DESCRIPTION OF DRAWINGS

FIG. 1 is a flowchart illustrating a process of matching two elements of the set {0, 1, . . . , r−1} with a single element of the set {±1, ±2, . . . , ±(r−1)} according to an exemplary embodiment of the present invention, in which two elements are selected from the set {0, 1, . . . , r−1} with duplication allowed and matched with a single element of the digit set {±1, ±2, . . . , ±(r−1)};

FIG. 2 is a flowchart illustrating a left-to-right recording process according to an exemplary embodiment of the present invention, in which an n-digit secret key represented in a set of {0, 1, . . . , r−1} is processed into an L-digit representation using a set {±1, ±2, ±(r−1)};

FIG. 3 is a flowchart illustrating a process of matching a set of {0, 1, . . . , r−1} with a set {±1, ±2, . . . , ±(r−1)} according to an exemplary embodiment of the present invention, in which (w+1) elements are selected from the set {0, 1, . . . , r−1} with duplication allowed and matched with w elements of the digit set {±1, ±2, . . . , ±(r−1)} with duplication allowed;

FIG. 4 is a flowchart illustrating a left-to-right recording process according to an exemplary embodiment of the present invention, in which an n-digit secret key represented in a set of {0, 1, . . . , r−1} is recorded into a radix-r^{w} notation using a set {±1, ±2, . . . , ±(r^{w}−1)}/{±r, ±2r, . . . , ±(r^{w}−r)};

FIG. 5 is a flowchart illustrating a process of scalar multiplication of kP unified with the left-to-right recording with the radix-r secret key k and a point P on an elliptic curve according to an exemplary embodiment of the present invention;

FIG. 6 is a flowchart illustrating a process of scalar multiplication kP unified with a left-to-right recording with a radix-r secret key k and a point P on an elliptic curve using a fixed window method according to an exemplary embodiment of the present invention;

FIG. 7 is a flowchart illustrating a process of scalar multiplication kP unified with a left-to-right recording with a binary secret key k and a point P on an elliptic curve according to an exemplary embodiment of the present invention; and

FIG. 8 is a flowchart illustrating a process of scalar multiplication kP unified with a left-to-right recording with a binary secret key k and a point P on an elliptic curve using a fixed window method according to an exemplary embodiment of the present invention.

### BEST MODE

According to an aspect of the present invention, there is provided a scalar multiplication method unified with a simple power analysis (SPA) resistant left-to-right recording in a cryptosystem using an elliptic curve and a pairing, the method comprising: recording an L-digit secret key k′ from a radix-r n-digit secret key k by comparing two successive elements with each other from the most significant digit with duplication allowed in order to generate the L-digit secret key k′; and performing scalar multiplication between the secret key k and a point P on an elliptic curve to output a scalar multiplication value Q=kP using the recorded secret key k′.

The recording may include: initializing the secret key k by comparing n and L; and generating the L-digit secret key k′ by comparing two successive elements from the most significant digit of the initialized secret key k with duplication allowed.

The recording may be performed such that, the recording result is set to (1−r) if both of two successive elements are 0, the recording result is set to (a lower digit element−r) if only the upper digit element is 0, the recording result is set to 1 if only the lower digit element is 0, and the recording result is set to the same value as the lower digit element, if both of the upper and lower digit elements are not 0.

The least significant digit of the secret key k may not be 0.

The recording may include sequentially comparing two successive elements with each other until the least significant digit element is compared.

According to another aspect of the present invention, there is provided a unified left-to-right scalar multiplication methods which is secure against simple power analysis (SPA) in a cryptosystem using an elliptic curve and a pairing, the method comprising: recording a radix-r n-digit secret key k to generate a secret key k′ having a window size w by selecting and sequentially arranging (w+1) elements from the secret key k with duplication allowed and comparing two successive elements with each other with duplication allowed according to an arrangement order; and performing a scalar multiplication value Q=kP between the secret key k and a point P on an elliptic curve using the recorded secret key k′.

The recording may include: inputting the window size w of the secret key k and selecting (w+1) elements from the secret key k with duplication allowed to arrange the elements in a selected order; and generating the secret key k′ having the window size w by sequentially comparing two successive elements of the arranged (w+1) elements with duplication allowed.

The recording may be performed such that, an element of the secret key k′ is set to (1−r) if both of two successive elements are 0, the secret key k′ is set to (a lower digit element−r) if only an upper digit element is 0, the secret key k′ is set to 1 if only a lower digit element is 0, and the secret key k′ is set to a lower digit element if both of the two elements are not 0.

The least significant digit of the secret key k′ may not be 0.

Two successive elements may be sequentially selected and compared until the least significant digit is compared.

According to another aspect of the present invention, there is provided a unified left-to-right scalar multiplication methods which is secure against simple power analysis (SPA) in a cryptosystem using on an elliptic curve and a pairing, the method comprising: recording a radix-r^{w} d-digit secret key k′ from a radix-r n-digit secret key k by selecting a smallest one of integers equal to or larger than n/w as d and comparing two successive elements starting from the most significant digit of the secret key k with duplication allowed; and performing scalar multiplication between the secret key k and a point P on an elliptic curve using the secret key k′ to output a scalar multiplication result Q=kP.

The recording may include: initializing the secret key k by comparing a multiplication dw of d and w with n; and generating the secret key k′ by sequentially comparing two successive elements of (w+1) elements of the initialized secret key k starting from the most significant digit with duplication allowed.

The recording may be performed such that, an element of the secret key k′ is set to (1−r) if both of two successive elements are 0, the secret key k′ is set to (a lower digit element−r) if only an upper digit element is 0, the secret key k′ is set to 1 if only a lower digit element is 0, and the secret key k′ is set to a lower digit element if both of the two elements are not 0.

The least significant digit of the secret key k may not be 0.

The recording may be performed such that two successive elements are sequentially selected and compared until the least significant digit element is compared.

The scalar multiplication may include: computing multiplication values iP between integers i ranging from 1 to (r−1) and the point P on an elliptic curve and storing the pre-multiplication values iP; extracting a initialized value kₙ₋₁P of an integer i corresponding to the most significant digit of the secret key k from the stored multiplication values and storing the initialized value kₙ₋₁P at a register Q; recording the secret key k′ from the secret key k such that an element of the secret key k′ is set to (1−r) if both of two successive elements are 0, an element of the secret key k′ is set to (a lower digit element−r) if only an upper digit element is 0, an element of the secret key k′ is set to 1 if only a lower digit element is 0, and an element of the secret key k′ is set to a lower digit element if both of the two elements are not 0; updating the scalar multiplication result Q using an r-tuple operation rQ of the previous scalar multiplication result Q as an intermediate scalar multiplication result Q; updating the scalar multiplication result Q by adding the stored value kⱼ′P to the intermediate result Q if the element kⱼ′ is positive and subtracting the stored value |kⱼ′|P from the intermediate result Q if the element kⱼ′ is negative; and outputting the updated scalar multiplication result Q after repeating the recording of the secret key k′ using elements of the secret key k until the least significant digit of the secret key k′ is recorded.

The method may further comprise determining whether or not the least significant digit k₀ of the secret key k is 0 or 1 and adding 1 or −1 to the least digit k₀ before computing the pre-multiplication values iP.

The process of outputting the updated scalar multiplication result Q may include: subtracting the P from the intermediate result Q when 1 is added to the least significant digit k₀ after the least significant digit of the secret key k′ is recorded, or adding the P to the scalar multiplication result Q when −1 is added to the least significant digit k₀ after the least significant digit of the secret key k′ is recorded.

The scalar multiplication may include: computing the pre-computation values iP between an element i of a digit set D_{w,r} and the point P on an elliptic curve and storing the multiplication value iP; extracting a initialized value tP with corresponding to the element i of the secret key k′ and the point P from the stored multiplication values and storing the value tP as the scalar multiplication result Q; updating the scalar multiplication result Q using r^{w} times the scalar multiplication result Q (r_{w}Q) as an intermediate scalar multiplication result Q;

updating the scalar multiplication result Q by adding the previously stored multiplication value kⱼ′P of the element kⱼ′ to the intermediate scalar multiplication result Q if the element kⱼ′ is positive and subtracting the previously stored multiplication value |kⱼ′|P from the intermediate scalar multiplication result Q if the element kⱼ′ is negative; and repeating the process of updating the scalar multiplication result Q until the least significant digit of the secret key k′ and outputting the updated scalar multiplication result Q.

The method may determining whether the least significant digit k₀ of the secret key k is 0 or 1 and adding 1 or −1 to the least digit k₀ before computing the multiplication value.

The updated scalar multiplication result Q may be obtained by subtracting P from the scalar multiplication result Q when 1 is added to the least significant digit k₀ after the least significant digit of the secret key k′ is updated, or adding the P to the scalar multiplication result Q when −1 is added to the least significant digit k after the least significant digit of the secret key k′ is updated.

According to another aspect of the present invention, there is provided a unified left-to-right scalar multiplication methods which is secure against simple power analysis (SPA) in a cryptosystem using an elliptic curve and a pairing, the method comprising: determining whether or not a least significant digit k₀ of a binary n-bit secret key k is 0 and adding 1 or 2 to the secret key k; storing a point P on an elliptic curve as a scalar multiplication result Q; sequentially determining whether or not each element of the secret key is 1 starting from the most significant bit and updating the scalar multiplication result Q by adding or subtracting the P to or from the previous scalar multiplication result Q; and updating the scalar multiplication result Q by subtracting P or 2P from the previous scalar multiplication result Q depending on the result of the determining of whether or not the least significant digit k₀ is 0.

The sequentially determining of whether or not each element of the secret key is 1 may be repeated until the least significant digit of the secret key k.

According to another aspect of the present invention, there is provided a unified left-to-right scalar multiplication methods which is secure against simple power analysis (SPA) in a cryptosystem using an elliptic curve and a pairing, the method comprising: determining whether or not the least significant digit k₀ of a binary n-bit secret key k is 0 and adding 1 or 2 to the secret key k; selecting a smallest one of integers equal to or larger than (n+1)/w as a value d to generate a radix-2^{w} d-digit secret key k′ from the secret key k; substituting dw-th bit k_{dw} with 1 depending on d and w and remaining elements ranged from (dw−1)-th bit to n-th digit with 0; computing multiplication values iP with an element i of a digit set D_{w,2} and the point P and storing the multiplication values iP; recording the most significant w bits and outputting a single result t corresponding to an element of a set D_{w,2}; successively receiving w digits and recording each digit into a single result kⱼ′ of the element of the set D_{w,2}; updating the scalar multiplication result Q using 2^{w} times the previous scalar multiplication result Q (i.e., 2^{w}Q) as an intermediate scalar multiplication result; updating the scalar multiplication result Q by adding the previously stored multiplication value kⱼ′P to the intermediate scalar multiplication result Q if the element kⱼ′ is positive or by subtracting the previously stored multiplication value |kⱼ′|P from the intermediate scalar multiplication result Q if the element kⱼ′ is negative; and

repeating the process of successively receiving w bits and recording each bit into a single result kⱼ′ of the set D_{w,2} until the least significant bit of the secret key k′ is recorded and updating the scalar multiplication result Q by subtracting P or 2P from the previous scalar multiplication result Q depending on whether or not the least significant bit k₀ is 0.

### MODE FOR INVENTION

Hereinafter, exemplary embodiments of the present invention will be described in detail with reference to the accompanying drawings. A scalar multiplication method of the present invention will be described for each algorithm shown in each drawing.

For convenience of description, some notations are defined as follows:

$${A}_{r} = \{ 0 , 1 , … , r - 1 \}$$

$${D}_{r} = \{ \pm 1 , \pm 2 , … , \pm ( r - 1 ) \}$$

$${A}_{w , r} = \{ 0 , 1 , … , {r}^{w} - 1 \}$$

$${D}_{w , r} = \{ \pm 1 , \pm 2 , … , \pm ( {r}^{w} - 1 ) \} / \{ \pm r , \pm 2 r , … , \pm ( {r}^{w} - r ) \}$$

$${( {a}_{n} , {a}_{n - 1} , … , {a}_{1} , {a}_{0} )}_{r} = {\sum }_{i = 0}^{n} {a}_{i} \cdot {{r}^{i} \\ ( {a}_{n} , {a}_{n - 1} , … , {a}_{1} , {a}_{0} )}_{{r}^{w}} = {\sum }_{i = 0}^{n} {a}_{i} \cdot {r}^{hv}$$

1. Left-to-Right Recording of an n-Digit Secret Key Represented by a Set {0, 1, . . . , r−1} into an L-Digit Representation Using a Digit Set {±1, ±2, . . . , ±(r−1)}

The basic idea of an integer recording based on radix-r representation without generating a bit “0” will be described. In the following, a positive representation of an integer “a” will be denoted as “a”, and a negative representation will be denoted as “a” instead of “−a”.

$$Conversion 1 \text{:} \{ \begin{matrix}{( 0 , 1 )}_{r} ⇔ {( 1 , \underline{r - 1} )}_{r} & {( 0 , \underline{1} )}_{r} ⇔ {( \underline{1} , r - 1 )}_{r} \\ {( 0 , 2 )}_{r} ⇔ {( 1 , \underline{r - 2} )}_{r} & {( 0 , \underline{2} )}_{r} ⇔ {( \underline{1} , r - 2 )}_{r} \\ ⋮ & ⋮ \\ {( 0 , r - 1 )}_{r} ⇔ {( 1 , \underline{1} )}_{r} & {( 0 , \underline{r - 1} )}_{r} ⇔ {( \underline{1} , 1 )}_{r}\end{matrix} \qquad [ Formula 2 ]$$

From the above Conversion 1, it is recognized that the right-to-left recording represented as a set Dᵣ can be readily derived. For example, if r=3, a given radix-3 representation (1, 0, 2, 0, 0, 1, 0, 2)₃ is sequentially recorded from the least significant digit using the above formula as follows: (*, *, *, *, *, *, 1, 1)₃ [symbol] (*, *, *, *, 1, 2, 1, 1)₃ [symbol] (*, *, *, 1, 2, 2, 1, 1)₃ [symbol] (*, 1, 1, 1, 2, 2, 1, 1)₃ [symbol] (1, 1, 1, 1, 2, 2, 1, 1)₃. A recorded result (1, 1, 1, 1, 2, 2, 1, 1)₃ obtained using the Conversion 1 is one of representations that can be obtained using the right-to-left recording of the set D₃.

The present invention proposes a left-to-right recording for converting any n-digit secret key k=(kₙ₋₁, . . . , k₁, k₀)ᵣ (where, kᵢ∈Aᵣ) into any L-digit secret key consisting of elements of a set Dᵣ. The recorded result is represented as k′=(k′_{L-1}, . . . , k′₁, k′₀)ᵣ (where, k′ᵢ∈Dᵣ). In this case, it is assumed that the least significant digit of the secret key k to be recorded is not set to “0” (i.e., k₀≠0).

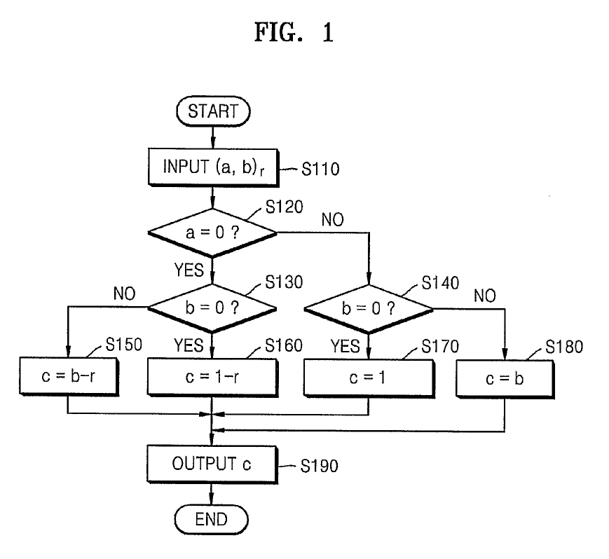

FIG. 1 is a flowchart illustrating a process of matching two elements of the set {0, 1, . . . , r−1} with a single element of the set {±1, ±2, . . . , ±(r−1)} according to an exemplary embodiment of the present invention, in which two elements selected from the set {0, 1, . . . , r−1} with duplication allowed are matched with a single element of the digit set {±1, ±2, . . . , ±(r−1)}. Additionally, FIG. 1 shows a method of determining an i-th digit k′ᵢ of the recorded key k′ by monitoring two digits (kᵢ₊₁, kᵢ), and its conditions can be expressed as follows:

$${k}_{i}^{′} = \{ \begin{matrix}{k}_{i} & if {k}_{i + 1} \cdot {k}_{i} \neq 0 ; \\ 1 & if {k}_{i + 1} \neq 0 and {k}_{i} = 0 ; \\ {k}_{i} - r & if {k}_{i + 1} = 0 and {k}_{i} \neq 0 ; \\ 1 - r & if {k}_{i + 1} = 0 and {k}_{i} = 0.\end{matrix} \qquad [ Formula 3 ]$$

Referring to FIG. 1, two successive digits (kᵢ₊₁, kᵢ) of the secret key k are input in operation S110, where kᵢ₊₁ corresponds to a, and kᵢ corresponds to b. If both of the two successive digits are not set to “0”, i.e., (kᵢ₊₁, kᵢ)=(≠0, ≠0), as determined in operation S120 and S140, the output value c becomes kᵢ in operation S180. That is, the recorded key k′ᵢ is the key kᵢ. If (kᵢ₊₁, kᵢ)=(≠0, 0), as determined in operation S120 and S140, the output value c becomes “1” in operation S170. If (kᵢ₊₁, kᵢ)=(0, ≠0), as determined in operation S120 and S130, the output value c becomes kᵢ−r in operation S150. If (kᵢ₊₁, kᵢ)=(0, 0), as determined in operation S120 and S130, the output value c becomes (1−r) in operation S160. It is recognized from Formula 3 that the output value c is equal to k′ᵢ, and k′ᵢ is an element of the set Dᵣ in operation S190. The flowchart of FIG. 1 can be defined as the following function.

c≈RECODE[a,b]

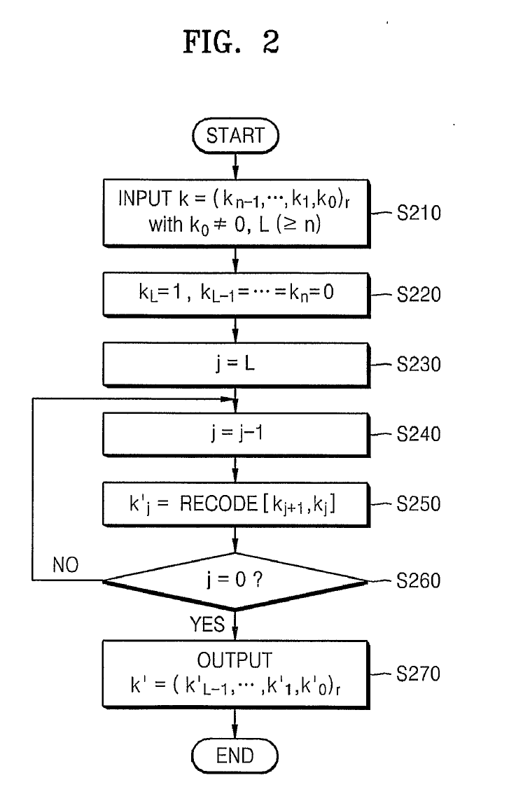

FIG. 2 is a flowchart illustrating a left-to-right recording process according to an exemplary embodiment of the present invention, in which an n-digit secret key represented in a set of {0, 1, . . . , r−1} is recorded into an L-digit representation using a set {±1, ±2, . . . , ±(r−1)}.

Referring to FIG. 2, the n-digit secret key k having a non-zero least significant digit (i.e., k₀≠0) and the length L of the recorded key k′ are input in operation S210, where the length L is equal to or larger than the number n. If the length L is equal to the number n (L=n), the k_{L} is substituted with 1 (k_{L}=1). If the length L is larger than the number n (L>n), the k_{L} is substituted with 1 (k_{L}=1), and the digits from k_{L-1} to kₙ are filled with zeros in operation S220. Also, the value of j is substituted with the length L in operation S230.

Subsequently, j is decremented to j−1 to start a decrementing loop in operation S240. An output value of the k′ⱼ for the input (kⱼ₊₁, kⱼ) is determined using the function RECODE[a, b] defined in FIG. 1 in operation S250. Then, it is determined whether or not j is equal to zero in operation S260, and, if not, the process returns to operation S240 to iterate the loop until j becomes zero. When j becomes zero, the recorded key k′=(k′_{L-1}, . . . , k′ᵢ, k′₀)ᵣ is output in operation S270.

For example, if the secret key k is set to k=(1, 0, 2, 0, 0, 1, 0, 2)₃, and the length is set to L=8, the algorithm shown in FIG. 2 performs the recording as follows:

$$k = {( 1 , 0 , 2 , 0 , 0 , 1 , 0 , 2 )}_{3} ⇒ {( 1 , * , * , * , * , * , * , * )}_{3} ⇒ {( 1 , 1 , * , * , * , * , * , * )}_{3} ⇒ {( 1 , 1 , \underline{1} , * , * , * , * , * )}_{3} ⇒ {( 1 , 1 , \underline{1} , 1 , * , * , * , * )}_{3} ⇒ {( 1 , 1 , \underline{1} , 1 , \underline{2} , * , * , * )}_{3} ⇒ {( 1 , 1 , \underline{1} , 1 , \underline{2} , \underline{2} , * , * )}_{3} ⇒ {( 1 , 1 , \underline{1} , 1 , \underline{2} , \underline{2} , 1 , * )}_{3} ⇒ {( 1 , 1 , \underline{1} , 1 , \underline{2} , \underline{2} , 1 , \underline{1} )}_{3}$$

2. Left-to-Right Recording of an n-Digit Secret Key, Represented by Elements of a Set {0, 1, . . . , r−1}, into an Radix-r^{w} Representation Using Elements of a Set {±1, ±2, . . . , ±(r^{w}−1)}/{±r, ±2r, . . . , ±(r^{w}−r)}

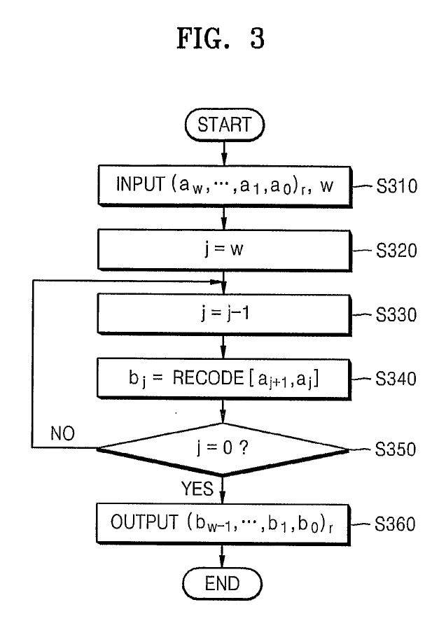

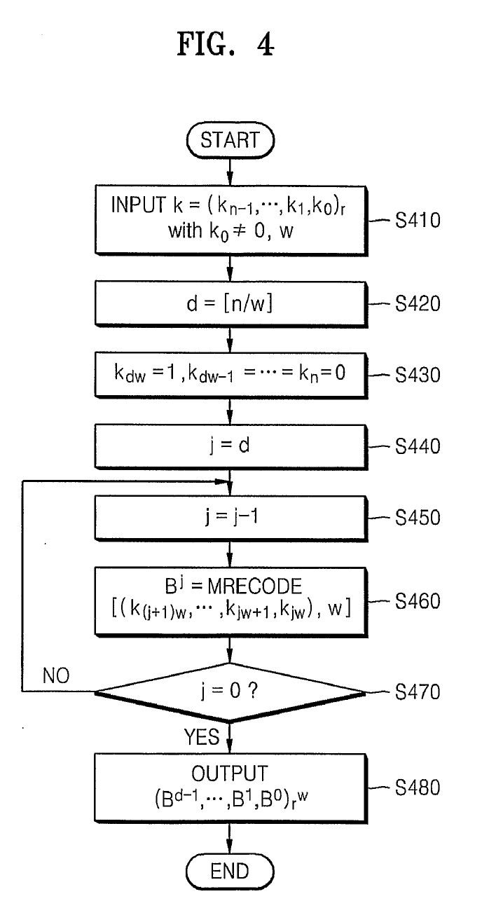

While the aforementioned left-to-right recording methods shown in FIGS. 1 and 2 are used to process the n-digit secret key on a single digit basis, the following left-to-right recording methods which will be described in connection with FIGS. 3 and 4 are used to simultaneously process the n-digit secret key on a plurality of digits basis.

That is, the following recording method is used to apply a fixed window to the above recording method of FIGS. 1 and 2.

FIG. 3 is a flowchart illustrating a process of matching a set of {0, 1, . . . , r−1} with a set {±1, ±2, . . . , ±(r−1)} according to an exemplary embodiment of the present invention, in which (w+1) elements are selected from the set {0, 1, . . . , r−1} with duplication allowed and matched with w elements of the digit set {±1, ±2, . . . , ±(r−1)} with duplication allowed.

That is, the algorithm shown in FIG. 3 is used to output w digits using the function RECODE[a,b] defined in FIG. 1. Firstly, the size w of output digits and (w+1) values of the aᵢ are input in operation S310. j is substituted with the size w in operation S320. Subsequently, j is decremented to j−1 to start a decrementing loop in operation S330. The value of bⱼ is determined using the function RECODE[a,b] defined in FIG. 1 in operation S340. Then, it is determined whether or not the value of j is equal to zero in operation S350, and the process returns to operation S330 to repeat the loop until the value of j becomes zero. When j becomes zero, a digit set (b_{w-1}, . . . , b₁, b₀)ᵣ is output in operation S360. As a result, the algorithm of FIG. 3 can be defined as the following function:

(b_{w-1}, . . . , b₁, b₀)ᵣ≈MRECODE[(a_{w}, . . . , a₁, a₀), w]

Since an output value of the function RECODE[a,b] defined in FIG. 1 belongs to an element of the set D_{,r,} it can be said that b₀≠0. Therefore, it is recognized that the output value of the function MRECODE[(a_{w}, . . . , a₁, a₀), w] contains no multiple of r, but one of the elements of the set D_{w,r}.

FIG. 4 is a flowchart illustrating a left-to-right recording process according to an exemplary embodiment of the present invention, in which an n-digit secret key represented as a set of {0, 1, . . . , r−1} is recorded into a radix-r^{w} notation using a set {±1, ±2, . . . , ±(r^{w}−1)}/{±r, ±2r, . . . , ±(r^{w}−r)}.

Referring to FIG. 4, an n-digit secret key k having a non-zero least significant digit (k₀≠0) and a fixed window size w are input in operation S410, where the window size w is selected from a group of integers larger than 1. In operation S420, a variable d is set to [n/w] obtained by using the digit size n of the secret key k and the window size w.

It should be noted that a symbol [R] denotes a smallest integer equal to or larger than a real number R, where R is any non-zero real number. For example, [2]=2, [2.2]=3, and [−2.2]=−2. In operation S430, if dw=n, then k_{dw}=1. If dw>n, then k_{dw}=1, and ‘0's’ are filled to the remaining digits from k_{dw-1} to kₙ. Also, d is substituted with j (j=d) in operation S440.

Subsequently, j is decrement to j−1 to start a decrementing loop in operation S450. The value of B^{j} is determined using the function MRECODE[(a_{w}, . . . , a₁, a₀), w] defined in FIG. 3 in operation S460. Then, it is determined whether or not j is equal to zero in operation S470, and the process returns to operation S450 and repeats the loop until j becomes zero. When j becomes zero, a digit set (B^{d-1}, . . . , B¹, B⁰)ᵣ^{w} is output in operation S480.

3. Scalar Multiplication kP Unified with a Left-to-Right Recording with a Radix-r Secret Key k and a Point P on an Elliptical Curve

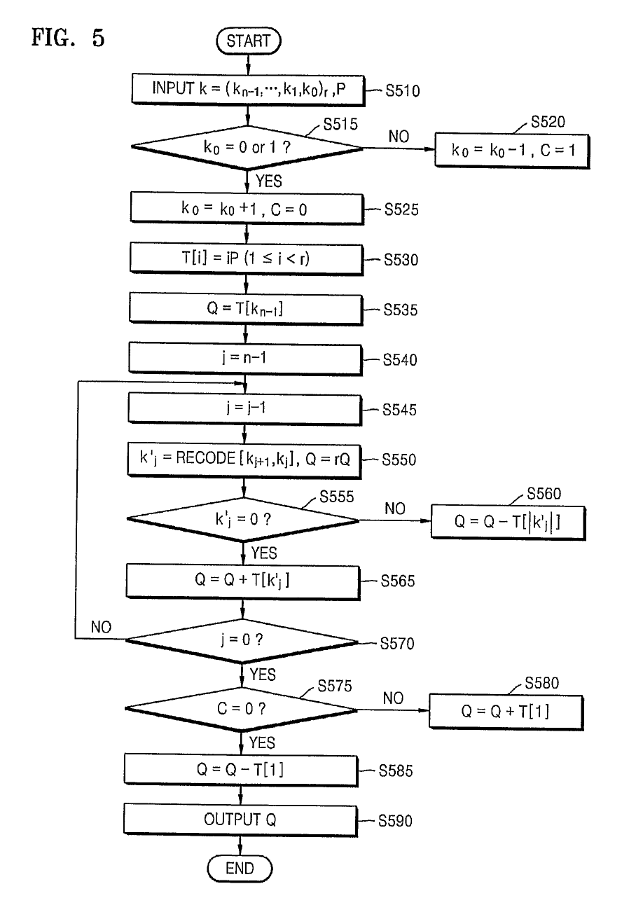

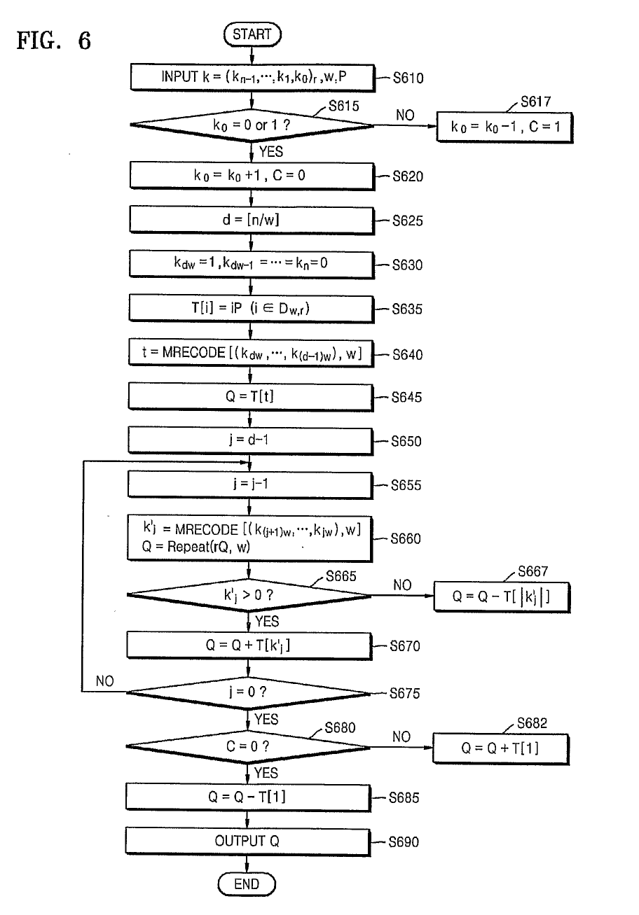

A left-to-right recording method of a secret key for exhibiting a fixed operating pattern resistant to a side channel attack has been described with reference to FIGS. 2 and 4. In FIGS. 5 and 6, a unified algorithm for simultaneously performing a conventional left-to-right scalar multiplication algorithm and the left-to-right recording shown in FIGS. 2 and 4 will be described below.

The present method may be called an SPA-resistant unified radix-r left-to-right scalar multiplication algorithm. Additionally, the present algorithm can be obtained by combining the recording method of FIG. 2 and a conventional left-to-right scalar multiplication algorithm.

FIG. 5 is a flowchart illustrating a process of scalar multiplication kP unified with a left-to-right recording with a radix-r secret key k and a point P on an elliptic curve according to an exemplary embodiment of the present invention.

Referring to FIG. 5, for scalar multiplication, a secret key k and a point P on an elliptic curve are input in operation S510. Then, it is determined whether or not the least significant digit k₀ of an n-digit secret key is one of 0 or 1 in operation S515. If it is determined that the least significant digit k₀ is not one of 0 or 1, k is decremented by 1, and a constant C is set to 1 in operation S520. Otherwise, k₀ is incremented by 1, and the constant C is set to 0 in operation S525, so that k₀ is not always set to 0. This procedure is to satisfy an input condition of FIG. 2.

In operation S530, a multiplication value iP is calculated and substituted with T[i], where 1≦i>r. A variable Q is substituted with T[kₙ₋₁] in operation S535, and j is substituted with (n−1) in operation S540. Then, j is decremented to j−1 to start a decrementing loop. A digit k′ⱼ is determined for the input value (kⱼ₊₁, kⱼ) using the function RECODE[a,b] defined in FIG. 1, and Q is substituted with a value of rQ in operation S550. If k′ⱼ has a negative sign, a value of Q−T[|k′ⱼ|] is computed and stored as Q in operation S560. However, if k′ⱼ has a positive sign, a value of Q−T[k′ⱼ] is computed and stored as Q in operation S565, where |k′ⱼ| denotes an absolute value of k′ⱼ.

Subsequently, it is determined whether or not j is equal to zero in operation S570, and the process returns to operation S545 to repeat the loop until j becomes zero. When j becomes zero, it is determined whether or not the constant C is zero. If the constant C is not zero, a value of Q+T[1] is computed and stored as Q in operation S580. If the constant C is zero, a value of Q−T[1] is computed and stored as Q, which is subsequently output in operation S590. The division to operation S580 or S585 depending on the value of the constant C in operation S575 is to correct the value of k₀ that has modified in operation S525 and allow the output Q to be equal to a value of kP.

FIG. 6 is a flowchart illustrating a process of scalar multiplication kP unified with a left-to-right recording with a radix-r secret key k and a point P on an elliptic curve using a fixed window method according to an exemplary embodiment of the present invention.

Specifically, the present algorithm is designed to apply a fixed window method to the SPA-resistant unified radix-r left-to-right scalar multiplication of FIG. 5.

Referring to FIG. 6, a secret key k, a point P on an elliptic curve, and a window size w are input in operation S610. If the window size w is fixed, it would be possible to omit the inputting of the value of w. Subsequently, it is determined whether or not the least significant digit k₀ of the n-digit secret key is one of 0 or 1 in operation S615. If it is determined that the least significant digit k₀ is not one of 0 or 1, the least digit k₀ is decremented by 1, and a constant C is set to 1 in operation S617. Otherwise, the least significant digit k₀ is incremented by 1, and the constant C is set to 0 in operation S620, so that the least significant digit k₀ is not always set to 0.

Subsequently, d is substituted with a value of [n/w] in operation S625. If dw=n, then k_{dw}=1. If dw>n, then k_{dw}=1, and the remaining digits kₙ from k_{dw-1} are filled with 0's in operation S630. In operation S635, T[i] is substituted with iP, where i∈D_{w,r}. A result of the function MRECODE[(k_{dw}, . . . , k_{(d-1)w}), w] is computed using the function MRECODE[(a_{w}, . . . , a₁, a₀), w] defined in FIG. 3, and input as t in operation S640. A value of T[t] is stored as Q in operation S645. j is substituted with (d−1) in operation S650.

In operation S655, j is decremented to j−1 to start a decrementing loop. The result of the function MRECODE[(k_{(j+1)w}, . . . , k_{jw+1}, k_{jw}), w] is stored as k′, and the Q is substituted with a value of Repeat(rQ, w), where Repeat(rQ, w)=r^{w}Q in operation S660. When k′ⱼ is negative, Q−T[|k′ⱼ|] is computed and stored as Q in operation S667. If k′ⱼ is positive, Q−T[k′ⱼ] is computed and stored as Q in operation S670, where |k′ⱼ| denotes an absolute value of k′ⱼ.

Subsequently, it is determined whether or not j is zero in operation S675. If j is not zero, the process returns to operation S655 to repeat the loop until j becomes zero. When j becomes zero, it is determined whether or not the constant C is zero. If it is determined that C is not zero, a value of Q+T[1] is computed and stored as Q in operation S682. Otherwise, if it is determined that C is zero, a value of Q−T[1] is computed and stored as Q in operation S685, and a final value of Q is output in operation S690. It should be noted that the division to operation S682 or S685 depending on the constant C is to correct the value of k₀ that has been modified in operation S617 and S620 and make the output Q to be the value of kP.

4. Scalar Multiplication kP Unified with a Left-to-Right Recording with a Binary Secret Key k and a Point P on an Elliptic Curve

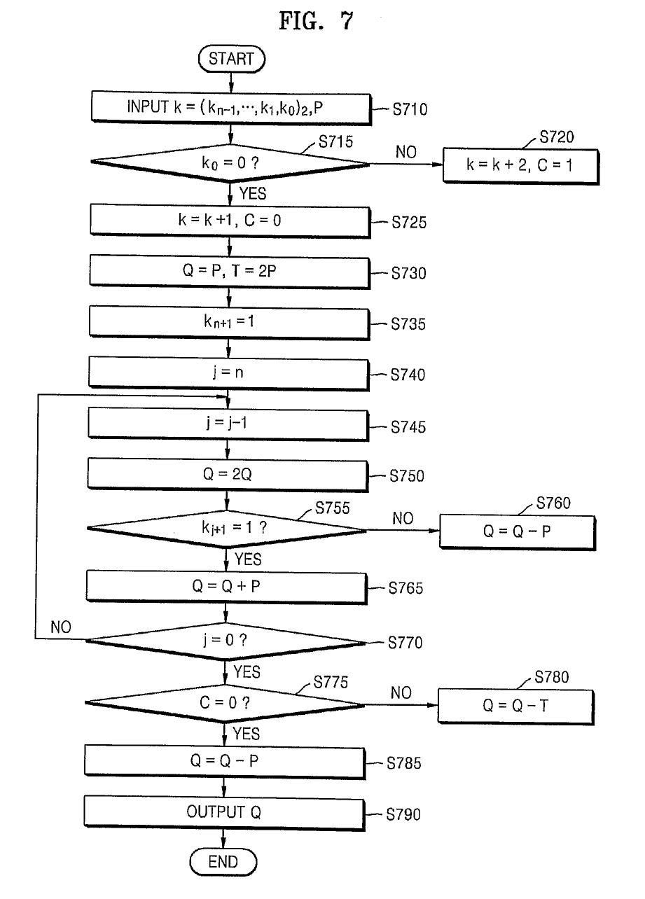

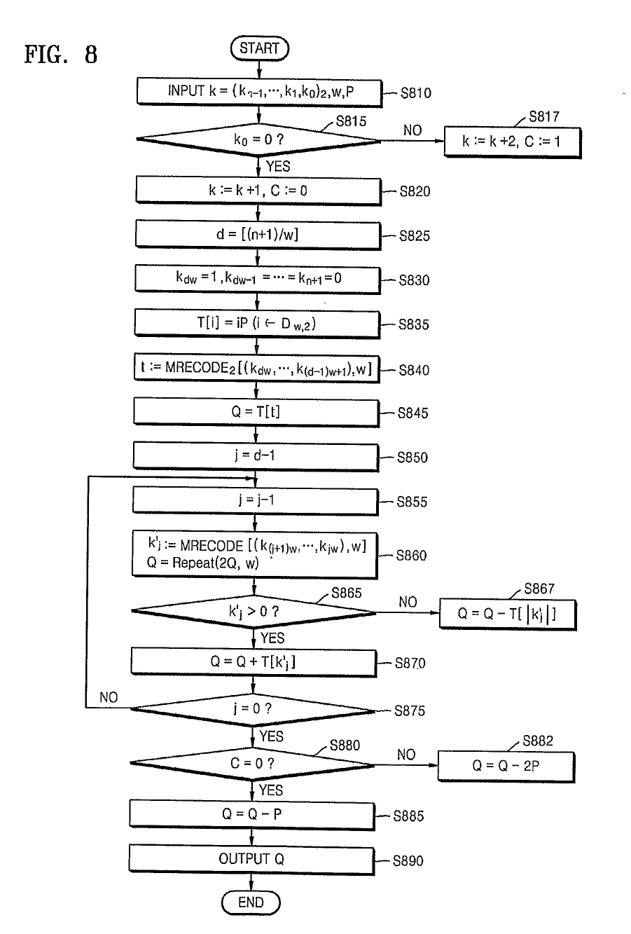

FIGS. 7 and 8 which will be described below show a scalar multiplication algorithm having a base of 2 (r=2) while FIGS. 5 and 6 that have been described above show a scalar multiplication algorithm having a base of any integer.

FIG. 7 is a flowchart illustrating a process of scalar multiplication kP unified with a left-to-right recording with a binary secret key k and a point P on an elliptic curve according to an exemplary embodiment of the present invention.

The present method may be called an SPA-resistant unified binary left-to-right scalar multiplication algorithm. Additionally, in the present algorithm, the base is selected as 2 (r=2) unlike the scalar multiplication algorithm of FIG. 5.

Referring to FIG. 7, for the scalar multiplication, a secret key k and a point P on an elliptic curve are input in operation S710. Then, it is determined whether or not the least significant bit k₀ of the n-bit secret key is 0 in operation S715. If it is determined that the least bit k₀ is not 0, the secret key k is incremented by 2, and the constant C is set to 1 in operation S720. Otherwise, the secret key k is incremented by 1, and the constant C is set to 0 in operation S725, so that the least bit k₀ is always set to a non-zero value. In operation S730, Q is set to the value of P, and T is set to the value of 2P. The (n+1)-th digit Kₙ₊₁ is set to 1 in operation S735, and j is set to n in operation S740.

Subsequently, the j is decremented to j−1 to start a decrementing loop in operation S745, and Q is doubled into 2Q in operation S750. If the (j+1)-th digit kⱼ₊₁ is 0, a value of Q−P is computed and stored as Q in operation S760. If the (j+1)-th digit kⱼ₊₁ is 1, a value of Q+P is computed and stored as Q in operation S765.

Subsequently, it is determined whether or not j is zero in operation S770, and the process returns to operation S745 to repeat the loop until j becomes zero. When j becomes zero, it is determined whether or not the constant C is zero. If it is determined that the constant C is not zero, then a value of Q−T is computed and stored as Q in operation S785 and the final value of Q is output in operation S790. The division to operation S780 or S785 depending on the constant C is to correct the value k that has been modified in operation S720 and S735 and set the output Q as kP.

In FIG. 7, operation S750 to 5765 can be simplified by setting r=2 in operation S550 to 5565 of FIG. 5. The formula 3 can be simplified by setting r=2 using the function RECODE[a,b] of operation S550 of FIG. 5 as follows.

| | | Formula 3 (a general | |
|---|---|---|---|
| Inputs (kᵢ₊₁, kᵢ) | Inputs (kᵢ₊₁, kᵢ) | value of r) | r = 2 |
| kᵢ₊₁ | kᵢ | Output k′ᵢ | Output k′ᵢ |
| ≠0 | ≠0 | kᵢ | 1 |
| ≠0 | 0 | 1 | 1 |
| 0 | ≠0 | kᵢ − r | −1 |
| 0 | 0 | 1 − r | −1 |

As can be seen from the above table, the i-th bit k′ᵢ can be determined by using only the value of the (i+1)-th bit from the two input values (kᵢ₊₁, kᵢ) when the base is set to 2 (r=2). More specifically, in the above formula 3, both the recording results of the first and second digits are 1, and the remaining two digits are −1. In this case, the (i+1)-th input value kᵢ₊₁ of the first two cases is 1, and the (i+1)-th input value of the remaining two cases is 0.

FIG. 8 is a flowchart illustrating a process of scalar multiplication kP unified with a left-to-right recording with a binary secret key k and a point P on an elliptic curve using a fixed window method according to an exemplary embodiment of the present invention.

In the present algorithm, a fixed window method is applied to the SPA-resistant unified binary left-to-right scalar multiplication of FIG. 7.

Referring to FIG. 8, for the scalar multiplication, a secret key k, a point P on an elliptic curve, and a window size w are input in operation S810. When the window size w is fixed, it would be possible to omit the inputting of the value of w. Subsequently, it is determined whether or not the least significant bit k₀ of the n-bit secret key is zero in operation S815. If it is determined that the least significant bit k₀ is not zero, k is incremented by 2, and the constant C is set to 1 in operation S817. Otherwise, k is incremented by 1, and the constant C is set to 0 in operation S820, so that the least significant bit k₀ is always set to a non-zero value.

A value of d is substituted with [(n+1)/w] in operation S825. If dw=n, then k_{dw}=1. If dw>n, then k_{dw}=1, and all the remaining bits from k_{dw-1} to k are set to 0 in operation S830. A value of iP is computed, and T[i] is set to iP in operation S835, where i∈D_{w,2}. A value of MRECODE₂[(k_{dw}, . . . , k_{(d-1)w+1}), w] is computed using a function MRECODE₂[(a_{w-1}, . . . , a₁, a₀), w] which is a binary version of the function MRECODE[(a_{w}, . . . , a₁, a₀), w] defined in FIG. 3 when r=2, and input to a value of t in operation S840. Then, a value of T[t] is stored as the Q in operation S845.

In operation S840, as a result of the function (b_{w-1}, . . . , b₁, b₀)₂=MRECODE₂[(a, . . . , a₁, a₀), w], bᵢ is set to −1 if aᵢ is zero, while bᵢ is set to 1 if aᵢ is 1, where 0≦i≦w−1.

j is substituted with (d−1) in operation S850. Subsequently, j is decremented to j−1 to start a decrementing loop in operation S855. The result of the function MRECODE₂[(k_{(j+1)w}, . . . , k_{jw+2}, k_{jw+1}), w] is stored as k′ⱼ, and Q is set to a result of Repeat(2Q, w) in operation S860, where Repeat(2Q, w)=2^{w}Q. When k′ⱼ is negative, a value of Q−T[|k′ⱼ] is computed and stored as Q in operation S867. When k′ⱼ is positive, a value of Q+T[k′ⱼ] is computed and stored as the Q in operation S870, where |k′ⱼ| denotes an absolute value of k′ⱼ.

Subsequently, it is determined whether or not j is zero in operation S875, and the process returns to operation S855 to repeat the loop until j becomes zero. When j becomes zero, it is determined whether or not the constant C is zero. If the constant C is not zero, Q−2P is computed and stored as Q in operation S822. If the constant C is zero, Q−P is computed and stored as Q in operation S885. Finally, the value of Q is output in operation S890. In this case, the division to operation S882 or S885 depending on the constant C is to correct the value of k that has been modified in operation S817 and S820 and make the output Q to be the value of kP.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A scalar multiplication method unified with a simple power analysis (SPA) resistant left-to-right recording in a cryptosystem using an elliptic curve and a pairing, the method comprising:
recording an L-digit secret key k′ from a radix-r n-digit secret key k by comparing two successive elements with each other from the most significant digit with duplication allowed in order to generate the L-digit secret key k′; and
performing scalar multiplication with the secret key k and a point P on an elliptic curve to output a scalar multiplication value Q=kP using the recorded secret key k′.

2. The scalar multiplication method according to claim 1, wherein the recording includes:
initializing the secret key k by comparing n and L; and
generating the L-digit secret key k′ by comparing two successive elements from the most significant digit of the initialized secret key k with duplication allowed.

3. The scalar multiplication method according to claim 1, wherein the recording is performed such that, the recording result is set to (1−r) if both of two successive elements are 0, the recording result is set to (a lower digit element−r) if only the upper digit element is 0, the recording result is set to 1 if only the lower digit element is 0, and the recording result is set to the same value as the lower digit element, if both of the upper and lower digit elements are not 0.

4. The scalar multiplication method according to claim 1, wherein the least significant digit of the secret key k is not 0.

5. The scalar multiplication method according to claim 1, wherein the recording includes sequentially comparing two successive elements with each other until the least significant digit element is compared.

6. A scalar multiplication method unified with a simple power analysis (SPA) resistant left-to-right recording in a cryptosystem using an elliptic curve and a pairing, the method comprising:
recording a radix-r n-digit secret key k to generate a secret key k′ having a window size w by selecting and sequentially arranging (w+1) elements from the secret key k with duplication allowed and comparing two successive elements with each other with duplication allowed according to an arrangement order; and performing a scalar multiplication value Q=kP with the secret key k and a point P on an elliptic curve using the recorded secret key k′.

7. The scalar multiplication method according to claim 6, wherein the recording includes:
inputting the window size w of the secret key k and selecting (w+1) elements from the secret key k with duplication allowed to arrange the elements in a selected order; and
generating the secret key k′ having the window size w by sequentially comparing two successive elements of the arranged (w+1) elements with duplication allowed.

8. The scalar multiplication method according to claim 6, wherein the recording is performed such that, an element of the secret key k′ is set to (1−r) if both of two successive elements are 0, the secret key k′ is set to (a lower digit element−r) if only an upper digit element is 0, the secret key k′ is set to 1 if only a lower digit element is 0, and the secret key k′ is set to a lower digit element if both of the two elements are not 0.

9. The scalar multiplication method according to claim 6, wherein a least significant digit of the secret key k′ is not 0.

10. The scalar multiplication method according to claim 6, wherein two successive elements are sequentially selected and compared until the least significant digit is compared.

11. A scalar multiplication method unified with a simple power analysis (SPA) resistant left-to-right recording in a cryptosystem using on an elliptic curve and a pairing, the method comprising:
recording a radix-r^{w} d-digit secret key k′ from a radix-r n-digit secret key k by selecting a smallest one of integers equal to or larger than n/w as d and comparing two successive elements starting from the most significant digit of the secret key k with duplication allowed; and
performing scalar multiplication between the secret key k and a point P on an elliptic curve using the secret key k′ to output a scalar multiplication result Q=kP.

12. The scalar multiplication method according to claim 11, wherein the recording includes:
initializing the secret key k by comparing a multiplication dw of d and w with n; and
generating the secret key k′ by sequentially comparing two successive elements of (w+1) elements of the initialized secret key k starting from the most significant digit with duplication allowed.

13. The scalar multiplication method according to claim 11, wherein the recording is performed such that, an element of the secret key k′ is set to (1−r) if both of two successive elements are 0, the secret key k′ is set to (a lower digit element−r) if only an upper digit element is 0, the secret key k′ is set to 1 if only a lower digit element is 0, and the secret key k′ is set to a lower digit element if both of the two elements are not 0.

14. The scalar multiplication method according to claim 11, wherein the least significant digit of the secret key k is not 0.

15. The scalar multiplication method according to claim 11, wherein the recording is performed such that two successive elements are sequentially selected and compared until the least significant digit element is compared.

16. The scalar multiplication method according to claim 1, wherein the scalar multiplication includes:
computing multiplication values iP with integers i ranging from 1 to (r−1) and the point P on an elliptic curve and storing the multiplication values iP;
extracting a multiplication value kₙ₋₁P of an integer i corresponding to the most significant digit of the secret key k from the stored multiplication values and storing the multiplication value kₙ₋₁P as the scalar multiplication result Q;
recording the secret key k′ from the secret key k such that an element of the secret key k′ is set to (1−r) if both of two successive elements are 0, an element of the secret key k′ is set to (a lower digit element−r) if only an upper digit element is 0, an element of the secret key k′ is set to 1 if only a lower digit element is 0, and an element of the secret key k′ is set to a lower digit element if both of the two elements are not 0;
updating the scalar multiplication result Q using an r-tuple operation rQ of the previous scalar multiplication result Q as an intermediate scalar multiplication result Q;
updating the scalar multiplication result Q by adding the stored multiplication value kⱼ′P to the intermediate scalar multiplication result Q if the element kⱼ′ is positive and subtracting the stored multiplication value |kⱼ′|P from the intermediate scalar multiplication result Q if the element kⱼ′ is negative; and outputting the updated scalar multiplication result Q after repeating the recording of the secret key k′ using elements of the secret key k until the least significant digit of the secret key k′ is recorded.

17. The scalar multiplication method according to claim 16, further comprising determining whether or not the least significant digit k of the secret key k₀ is 0 or 1 and adding 1 or −1 to the least significant digit k₀ before computing the multiplication values iP.

18. The scalar multiplication method according to claim 16, wherein the process of outputting the updated scalar multiplication result Q includes:
subtracting the P from the scalar multiplication result Q when 1 is added to the least significant digit k₀ after the least significant digit of the secret key k′ is recorded, or
adding the P to the scalar multiplication result Q when −1 is added to the least significant digit k₀ after the least significant digit of the secret key k′ is recorded.

19. The scalar multiplication method according to claim 11, wherein the scalar multiplication includes:
computing multiplication values iP with an element i of a digit set D_{w,r} and the point P on an elliptic curve and storing the multiplication value iP;
extracting a multiplication value tP with t corresponding to the element i of the secret key k′ and the point P from the stored multiplication values and storing the multiplication value tP as the scalar multiplication result Q;
updating the scalar multiplication result Q using r^{w} times the scalar multiplication result Q (r^{w}Q) as an intermediate scalar multiplication result Q;
updating the scalar multiplication result Q by adding the previously stored multiplication value kⱼ′ of the element kⱼ′ to the intermediate scalar multiplication result Q if the element kⱼ′ is positive and subtracting the previously stored multiplication value |kⱼ′|P from the intermediate scalar multiplication result Q if the element kⱼ′ is negative; and
repeating the process of updating the scalar multiplication result Q until the least significant digit of the secret key k′ and outputting the updated scalar multiplication result Q.

20. The scalar multiplication method according to claim 19, further comprising determining whether the least significant digit k₀ of the secret key k is 0 or 1 and if it is 0 or 1, adding 1 to the least significant digit k₀ before computing the multiplication value iP, otherwise, adding −1 to the least digit k₀ before computing the multiplication value.

21. The scalar multiplication method according to claim 18, wherein the updated scalar multiplication result Q is obtained by subtracting P from the scalar multiplication result Q when 1 is added to the least significant digit k₀ after the least significant digit of the secret key k′ is updated, or adding the P to the scalar multiplication result Q when −1 is added to the least significant digit k₀ after the least significant digit of the secret key k′ is updated.

22. A scalar multiplication method unified with a simple power analysis (SPA) resistant left-to-right recording in a cryptosystem using an elliptic curve and a pairing, the method comprising:
determining whether or not the least significant digit k₀ of a binary n-bit secret key k is 0 and adding 1 or 2 to the secret key k;
storing a point P on an elliptic curve as a scalar multiplication result Q;
sequentially determining whether or not each element of the secret key is 1 starting from the most significant digit and updating the scalar multiplication result Q by adding or subtracting the P to or from the previous scalar multiplication result Q; and
updating the scalar multiplication result Q by subtracting P or 2P from the previous scalar multiplication result Q depending on the result of the determining of whether or not the least significant bit k₀ is 0.

23. The scalar multiplication method according to claim 22, wherein the sequentially determining of whether or not each element of the secret key is 1 is repeated until the least significant bit of the secret key k.

24. A scalar multiplication method unified with a simple power analysis (SPA) resistant left-to-right recording in a cryptosystem using an elliptic curve and a pairing, the method comprising:
determining whether or not the least significant digit k₀ of a binary n-bit secret key k is 0 and adding 1 or 2 to the secret key k;
selecting a smallest one of integers equal to or larger than (n+1)/w as a value d to generate a radix-2^{w} d-digit secret key k′ from the secret key k;
substituting dw-th digit k_{dw} with 1 depending on d and w and remaining elements ranged from (dw−1)-th digit to n-th digit with 0;
computing multiplication values iP with an element i of a digit set D_{w,2} and the point P and storing the multiplication values iP;
recording the most significant w bits and outputting a single result t corresponding to an element of a set D_{w,2};
successively receiving w bits and recording each bit into a single result kⱼ′ of the element of the set D_{w,2};
updating the scalar multiplication result Q using 2^{w} times the previous scalar multiplication result Q (i.e., 2^{w}Q) as an intermediate scalar multiplication result; updating the scalar multiplication result Q by adding the previously stored multiplication value kⱼ′P to the intermediate scalar multiplication result Q if the element kⱼ′ is positive or by subtracting the previously stored multiplication value |kⱼ′|P from the intermediate scalar multiplication result Q if the element kⱼ′ is negative; and
repeating the process of successively receiving w bits and recording each digit into a single result kⱼ′ of the set D_{w,2} until the least significant bit of the secret key k′ is recorded and updating the scalar multiplication result Q by subtracting P or 2P from the previous scalar multiplication result Q depending on whether or not the least digit k₀ is 0.
